(19) United States
(12) Patent Application Publication
(10) Pub. No.: US 2025/0147522 A1
(43) Pub. Date: May 8, 2025

(54) CONTROL SYSTEM FOR CONTROLLING A PLURALITY OF MARINE VESSELS

(71) Applicant: Vector Controls Inc., Newton, MA (US)

(72) Inventor: Robert A. Morvillo, Dover, MA (US)

(73) Assignee: Vector Controls Inc., Newton, MA (US)

(21) Appl. No.: 18/948,673

(22) Filed: Nov. 15, 2024

Related U.S. Application Data
(63) Continuation of application No. PCT/US2023/067144, filed on May 17, 2023.
(60) Provisional application No. 63/343,000, filed on May 17, 2022.

(51) Int. Cl. G05D 1/695; G05D 1/24; G05D 1/606; G05D 107/00; G05D 109/30; G05D 111/30; H04W 4/40

(52) U.S. Cl. CPC G05D 1/696; G05D 1/24; G05D 1/606; H04W 4/40; G05D 2107/28; G05D 2109/34; G05D 2111/30

(57) ABSTRACT

A control system for controlling movement, position, or force for a mechanically connected object comprising a plurality of marine vessels. The control system includes at least one processor configured to: receive a movement, position or force command for the mechanically connected object; and generate at least one first command for a first marine vessel of the plurality of marine vessels and at least one second command for a second marine vessel of the plurality of marine vessels, to control movement, position, or force of the mechanically connected object in response to the movement, position or force command for the mechanically connected object.

### CROSS REFERENCE TO RELATED APPLICATIONS

The present application is a Continuation of International Patent Application Serial No. PCT/US2023/067144, filed May 17, 2023, entitled “CONTROL SYSTEM FOR CONTROLLING A PLURALITY OF MARINE VESSELS ”, which claims the benefit under 35 U.S.C. § 119(e) of provisional application 63/343,000, filed May 17, 2022, titled “CONTROL SYSTEM FOR CONTROLLING A PLURALITY OF MARINE VESSELS TO MANEUVER AN OBJECT,” each of which is hereby incorporated by reference in its entirety.

### TECHNICAL FIELD

The apparatus and techniques described herein relate to control of marine vessels.

### BACKGROUND

Marine vessels may include a propulsion system that includes one or more propulsors/thrusters/rudders that control a marine vessel in the water. Non-limiting examples of propulsors include propellors and waterjets.

### SUMMARY

Some aspects relate to a control system for controlling movement, position, or force for a mechanically connected object comprising a plurality of marine vessels. The control system includes at least one processor configured to: receive a movement, position or force command for the mechanically connected object; and generate at least one first command for a first marine vessel of the plurality of marine vessels and at least one second command for a second marine vessel of the plurality of marine vessels, to control movement, position, or force of the mechanically connected object in response to the movement, position or force command for the mechanically connected object.

The mechanically connected object may further comprise an assisted object.

The control system may further comprise at least one memory storing computer readable instructions for the at least one processor to generate the at least one first command and the at least one second command.

The control system may be configured to provide the at least one first command to the first marine vessel and the at least one second command to the second marine vessel.

The control system may be located at the assisted object or located remotely from the mechanically connected object.

The control system may receive a control input from an input device located at the assisted object or located remotely from the mechanically connected object.

The control system may be configured to provide the at least one first command to the first marine vessel and the at least one second command to the second marine vessel through wireless communication.

The control system may be configured to configured to provide the at least one first command to a first marine vessel control system of the first marine vessel and to provide the at least one second command to a second marine vessel control system of the second marine vessel.

A marine vessel control system for the first marine vessel may at least partially implement the control system for controlling movement of the mechanically connected object.

The control system may receive a control input from an input device located at the first marine vessel, and the control system controls both the first marine vessel and the second marine vessel.

The control system may be configured to provide the at least one second command to the second marine vessel.

The control system may be configured to provide the at least one second command to the second marine vessel through wireless communication.

The control system may be configured to provide the at least one second command to a second marine vessel control system of the second marine vessel.

The control system may be configured to maintain a position.

The control system may be configured to receive the movement, position or force command from a human operator, an autonomous system or a remotely controlled system.

The control system may be configured to control the first marine vessel and the second marine vessel such that the mechanically connected object keeps station or transits at least partially across a body of water.

The control system may be configured to detect a position and/or orientation of the first and second marine vessels relative to the assisted object or each other.

The control system may be configured to adjust the position and/or orientation of the first and/or second marine vessels relative to the assisted object or each other.

The control system may be configured to set or adjust one or more control parameters based on the position and/or orientation of the first and second marine vessels relative to the assisted object or each other.

The control system may be configured to control a plurality of marine vessels attached to the assisted object when one or more of the plurality of marine vessels are in longitudinal configuration, a modified longitudinal configuration and/or a transverse configuration.

The first and second marine vessels may be attached to the assisted object at an angle that is different corresponding to an angle corresponding to a longitudinal or transverse arrangement.

Some aspects relate to a system comprising the control system of any preceding claim, the assisted object, the first marine vessel and/or the second marine vessel.

Some aspects relate to a method of controlling movement, position, or force of a mechanically connected object comprising a plurality of marine vessels, the method comprising, by at least one processor: receiving a movement, position or force command for the mechanically connected object; and generating at least one first command for a first marine vessel of the plurality of marine vessels and at least one second command for a second marine vessel of the plurality of marine vessels, to control movement, position, or force of the mechanically connected object in response to the movement, position or force command.

Some aspects relate to at least one computer readable storage medium having stored thereon instructions, which, when executed by at least one processor, perform a method of controlling movement, position, or force of a mechanically connected object comprising a plurality of marine vessels, the method comprising: receiving a movement, position or force command for the mechanically connected object; and generating at least one first command for a first marine vessel of the plurality of marine vessels and at least one second command for a second marine vessel of the plurality of marine vessels, to control movement, position, or force of the mechanically connected object in response to the movement, position or force command.

Some aspects relate to a control system for controlling movement, position, or thrust of a waterborne object, comprising: at least one processor configured to: receive a movement, position or thrust command for the waterborne object; and generate at least one first command for a first marine vessel attached to the waterborne object and at least one second command for a second marine vessel attached to the waterborne object, to propel the waterborne object in response to the movement, position or thrust command for the waterborne object.

The control system may further comprise at least one memory storing computer readable instructions for the at least one processor to generate the at least one first command and the at least one second command.

A control system for the first marine vessel may implement the control system for controlling movement of the waterborne object.

Some aspects relate to a method of controlling movement, position, or thrust of a waterborne object, the method comprising, by at least one processor: receiving a movement, position or thrust command for the waterborne object; and generating at least one first command for a first marine vessel attached to the waterborne object and at least one second command for a second marine vessel attached to the waterborne object, to propel the waterborne object in response to the movement, position or thrust command for the waterborne object.

The foregoing summary is provided by way of illustration and is not intended to be limiting.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing.

FIG. 1 illustrates a plurality of marine vessels may be connected to an assisted object (e.g., floating platform) for the purpose of propelling the assisted object through the water.

FIG. 2 shows an example of a “rafting” procedure that may be employed to convey a floating platform across a body of water in the presence of a current.

FIG. 3 illustrates a first embodiment in which the object control system is located at an assisted object.

FIG. 4 illustrates another embodiment in which control of the assisted object is performed by an object control algorithm integrated into an existing control system of a marine vessel.

FIG. 5 shows an example in which four marine vessels are attached to and propel the assisted object.

FIG. 6 shows an example of a “transverse” configuration in which marine vessels are attached to the assisted object at their bows, with the centerline of the marine vessels being perpendicular to the long axis of the assisted object.

FIG. 7 shows an example with three marine vessels in which marine vessels are in a “transverse” configuration and marine vessel is in a position in which its bow is facing one end (left side) of assisted object.

FIG. 8 shows a modified longitudinal configuration, in which the marine vessels are attached to the assisted object at an angle, i.e., the centerline of the marine vessels is at an angle (between 0 and 90 degrees) with respect to the main axis of the assisted object.

FIG. 9 shows an embodiment in which two marine vessels are attached to one another, and an integrated control system may control one or both vessels.

FIG. 10 shows an embodiment in which three marine vessels are attached to one another, and an integrated control system may control one or more of the vessels.

FIG. 11 shows an embodiment similar to that of FIG. 9, with a marine vessel being attached to the side of another marine vessel in a transverse configuration.

### DETAILED DESCRIPTION

A marine vessel may have a control system that controls the propulsion system of the marine vessel in response to commands received from an operator or a computing device such as what might be found in an autonomous or remotely controlled system. Examples of commands include a translational force or movement command to translate (i.e., move) the vessel in a selected direction, and a rotational force or movement command to rotate the vessel. In response to the commands, the control system may control one or more propulsors to achieve the desired movement of the marine vessel. The marine vessel can also be equipped with rudders and/or thrusters. Some examples of control techniques are described in U.S. Pat. Nos. 7,222,577, 8,858,278, 9,937,994 and U.S. Published Patent Application 2022/0135196, each of which is hereby incorporated by reference in its entirety.

The inventor recognized and appreciated it can be advantageous to have a control system control a plurality of marine vessels. Such a control system may be advantageous when a plurality of marine vessels cooperate with one another to perform a task. A control system that controls a plurality of marine vessels in a cooperative manner may have various advantages such as improved control, reduced need for human involvement, and/or improved maneuvering and station keeping capabilities.

One application is in ferrying or “rafting” objects across a body of water, such as a river. A floating platform may load objects (“cargo”) at one side of the body of water, be conveyed across the body of water, and unload the cargo at the other side of the river. The cargo may be any objects, such as vehicles, containers, equipment, etc., for any purpose, including military or civilian purposes. The floating platform may be any suitable floating platform, and may, for example, include a number of connected pontoon bridge sections, a raft, a barge, or any other suitable floating platform.

A plurality of marine vessels may cooperate to convey the floating platform across the body of water. The marine vessels may attach or tie up to the floating platform at any suitable location. According to prior “rafting” techniques, a “captain” of the floating platform would issue hand and/or verbal signals to crew of the marine vessels, instructing them in how to control their respective marine vessels to attempt to maneuver the floating platform in a desired direction. However, such techniques have a number of disadvantages. In particular, the captain has limited control over the movement of the floating platform, as signaling commands to the crew on the respective marine vessels provides only coarse control of the movement of the floating platform and it is difficult to coordinate or synchronize the force applied by each vessel.

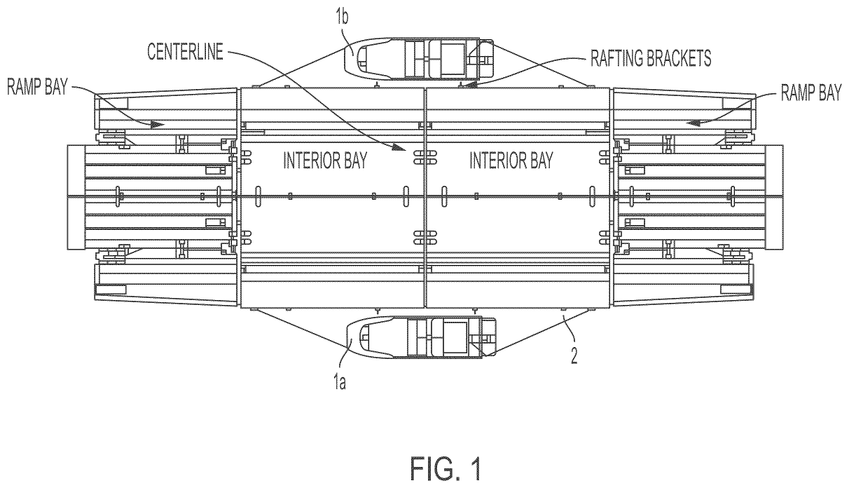

FIG. 1 illustrates a plurality of marine vessels 1a and 1b may be connected to an assisted object 2 (e.g., a floating object or platform, or a submerged object) for the purpose of propelling the assisted object 2 through the water. In this example, the combination of the marine vessels and the assisted object that are mechanically connected together collectively form a mechanically connected object. The marine vessels 1a and 1b may be attached to the assisted object 2 by at least one attachment apparatus, which may be any device for attaching a marine vessel to the assisted object, such as a bar, bracket, rope, a latch, or an integral part of a vessel and/or assisted object, by way of example and not limitation. In some embodiments, the means of attachment (e.g., attachment apparatus) may transmit most, and optionally all forces and moments between a marine vessel and the assisted object. In this case, the assisted object 2 is a connected set of four pontoon bridge sections (“raft”) including two interior sections and two ramp sections and the two ends of the raft. However, the techniques described herein are not limited as to the number of pontoon bridge sections included in the raft, which could be greater than or less than four, and the assisted object 2 is not limited to a raft of pontoon bridge sections, as the assisted object 2 may be any type of floating platform or other assisted object, such as a marine vessel (e.g., a disabled marine vessel under tow or being pushed). Cargo may be positioned on one or more of the sections and conveyed across a body of water on the assisted object 2, and may be unloaded at a suitable location (e.g., the other side of a body of water).

The assisted object 2 may be any of a variety of objects, not limited to rafts. The assisted object 2 may or may not have its own propulsion system. For example, the assisted object 2 may be a raft without a propulsion system. As another example, the assisted object 2 may be a marine vessel with a propulsion system. As one example, the assisted object 2 may be a ship without a bow thruster, and a marine vessel may be mechanically attached to the ship at its bow to use its propulsion system as a bow thruster (e.g., for a docking maneuver) to push the bow of the ship to port or starboard. An integrated control system may control both the propulsion system of assisted object 2 and the marine vessel.

Returning to the example of FIG. 1, each of the marine vessels 1a and 1b are independent marine vessels that may be detached from the assisted object 2 and perform other functions, such as transporting individuals, conducting search and rescue, pushing, towing, or any other tasks or operations. Each of marine vessels 1a and 1b has their own one or more propulsors to propel them through the water, and may have control systems for controlling the one or more propulsors. The one or more propulsors may be steerable and/or the marine vessel may include a steering system to steer the vessel, based on commands from the control system. The control systems may include one or more processors and at least one memory. The at least one processor may receive marine vessel control commands such as translational and rotational force or movement commands (e.g., from an input interface such as a joystick, helm, throttle(s), control levers, remote system, autonomous system, etc.), and produce appropriate commands to one or more “effectors” which may be one or more propulsors (which may be fixed or steerable propulsors), a steering system (e.g., one or more actuated rudders), or one or more thrusters, depending on the received marine vessel configuration. The at least one memory may store a mapping between received marine vessel control commands and commands to be output by the control system to control the one or more propulsors, steering system and/or one or more thrusters.

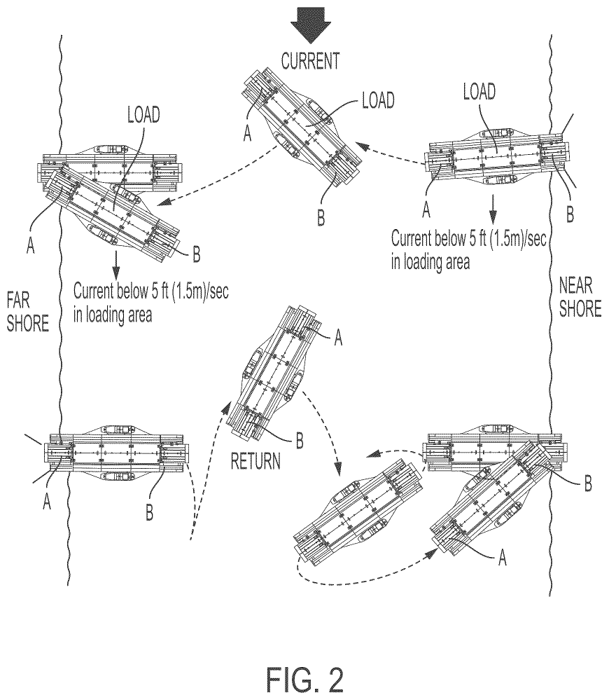

When attached to the assisted object 2, one or more marine vessels such as 1a and 1b may cooperate with each other and/or the assisted object 2 to propel the assisted object 2 through the water or hold the assisted object 2 in position. FIG. 2 shows an example of a “rafting” procedure that may be employed to convey a floating platform across a body of water in the presence of a current. Controlling the marine vessels independently may limit control over the movement of assisted object 2, leading to proposed rafting maneuvers such as are shown in FIG. 2, in which the marine vessels propel the assisted object 2 into the current to attempt a landing at a corresponding location on the opposite shore.

Improved control of the movement of assisted object 2 may be achieved through use of an object control system or algorithm that controls one or both of marine vessels 1a and 1b. Optionally the object control system may also control a propulsion system of the assisted object. Based on commands from an operator, a remote system, and/or an autonomous system, which may be movement commands, position commands and/or force commands, the object control system may determine individual commands to apply to the individual marine vessels 1a, 1b and/or assisted object 2 to control movement of the assisted object 2. The object control system/algorithm may enhance maneuverability by removing or reducing the need for a human to issue commands to individual marine vessels. In contrast to the limited parameters that can be conveyed by hand signals, an object control system/algorithm can increase precision, speed, and complexity of maneuvers that can be commanded. For example, a number of commands may be provided such as steering commands or RPM commands for one or more propulsors. The precision of commands may be increased, as limited precision may be possible with hand or verbal commands, whereas a control system may provide commands with high precision. The control system may provide for real time coordination and synchronization of the marine vessels. The control system may enhance maneuverability by controlling the marine vessels and their respective propulsors in ways that were not previously achievable. For example, the marine vessels and/or assisted object may be controlled to collectively act as a single vessel having a plurality of propulsors at respective positions of the assisted object 2. Both simple and complex maneuver commands can be quickly resolved by the object control system into individual propulsor, steering, and force commands, and transmitted to the respective vessel control systems in a coordinated way. This can allow sophisticated control techniques to be implemented for the mechanically connected object as a whole. For example, the control techniques for dual or multi-propulsor marine vessels such as those described in in U.S. Pat. Nos. 7,222,577, 8,858,278, 9,937,994 and U.S. Published Patent Application 2022/0135196 may be implemented, with each of the marine vessels effectively acting as one or more propulsors of a dual or multi-propulsor marine vessel.

Various control techniques may be implemented by the object control system. For example, in some embodiments, translational, rotational and/or force commands for the assisted object 2 (or for the mechanically connected object including assisted object 2 and/or one or more marine vessels) may be mapped by the object control system/algorithm into commands provided to the individual control systems of the marine vessels 1a and 1b to produce force vectors selected to maneuver assisted object 2 in a desired manner or to hold station. In some embodiments, the control system may implement dynamic positioning (DP). In a DP control system, a desired position and/or heading of the assisted object (or marine vessel(s)) along with sensor data such as present position, or other sensor data, is received as an input to the DP control system, and the DP control system determines commands to produce the appropriate force to achieve the commanded position or track. The desired position and/or heading may be received from a human operator through any suitable user interface (e.g., through an input device such as a touch screen, joystick, keyboard, buttons, etc.) located at any location such as at any point on the assisted object 2, or a marine vessel 1a or 1b or at a remote location in wired or wireless communication with a communication interface of the control system. The desired position and/or heading may be received from an autonomous and/or remote control system that controls movement of assisted object 2, which may be integrated into the same control system or a separate system at any location where it can be in communication with the control system for the assisted object 2.

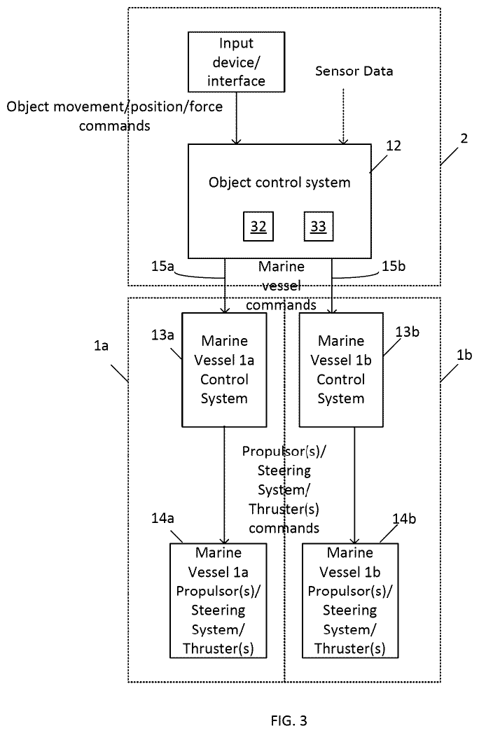

FIG. 3 illustrates a first embodiment in which the object control system 12 is located at the assisted object 2. The object control system 12 may include a computing device with processor(s) 32 and at least one memory 33. The processor(s) 32 may receive commands relating to motion or position or force for the marine vessel, and optionally sensor data (e.g., regarding position, current, wind, etc.), and generate commands for the control systems of the individual marine vessels to control their respective one or more propulsors to produce force vectors to obtain desired movement of the assisted object 2. The at least one memory 33 may store software to implement the object control system and a mapping between received commands relating to motion or position of the marine vessel and optional input sensor data, into marine vessel commands 15a, 15b to be provided to the marine vessels 1a, 1b, respectively. Based on the commands 15a, 15b received by the marine vessels, the control systems 13a, 13b of the marine vessels 1a, 1b, respectively produce suitable effector commands, such as steering and/or force commands to one or more propulsors and/or a steering system 14a, 14b, respectively. The object control system 12 may be at any location, including on the assisted object 2, or at another location such as on one of the marine vessels 1a or 1b, or at a remote location.

In some embodiments, the object control system 12 may implement a DP system to direct the assisted object 2 on a desired course or heading, based on received commands and position information received from one or more sensors (e.g., a global navigation satellite system receiver, a compass, a gyroscope, an accelerometer, wind sensor, current sensor, or a draft or weight sensor for the assisted object and/or one or more marine vessels, etc.). For some assisted objects, such as those without dedicated controls (e.g., a raft of pontoon bridge sections), the object control system 12 may be implemented in a portable control unit, such as a portable computing device (e.g., a console, terminal, laptop computer, tablet computer, smartphone, etc.). The portable control unit may be located anywhere it can be in communication with the marine vessels 1a and 1b, such as on the assisted object 2, on one of the marine vessels 1a or 1b, or at a remote location. The object control system 12 may be a dedicated system permanently installed on the assisted object 2 or otherwise implemented as part of an integrated control system for the assisted object 2. For example, an assisted object may be assisted (partially or completely) by being pushed or towed by one or more marine vessels. For example, an assisted marine vessel may be a vessel that obtains assistance in docking or traversing a channel using at least one marine vessel. If the assisted object 2 is an assisted marine vessel having a control system, the control system of the assisted marine vessel may operate in a mode (i.e., a towing or pushing mode), in which the control system of the assisted marine vessel controls the marine vessels 1a, 1b to operate their propulsors in a manner that propels the towed marine vessel through the water. The object control system 12 may be in communication with the marine vessel control systems 13a, 13b to send information, such as commands 15a, 15b, through any type of connection such as a wired or wireless connection, as the techniques described herein are not limited to particular types of connections.

FIG. 4 illustrates another embodiment in which control of the assisted object is performed by an object control algorithm 42 incorporated into an existing control system of a marine vessel 1a (or 1b) that propels the assisted object. This embodiment may have the advantage of avoiding the need for a control system or console, etc., separate from those of the marine vessels (e.g., 1a, 1b). In this example, marine vessel 1a may have a marine vessel control system 13a having at least one processor 32 and at least one memory 33 memory storing software (e.g., object control algorithm 42) and/or a mapping, that implements the functions of the object control system 12 described above. The object control algorithm 42 may be software that has any of the characteristics of or performs any of the functions the object control system 12 described above. The object control algorithm 42 may generate commands 15a, 15b for both the marine vessel 1a and the marine vessel 1b. Marine vessel control system 13a may map the commands 15a for marine vessel 1a into commands for the propulsor(s)/steering system/thruster(s) 14a of marine vessel 1a. The object control algorithm 42 may be in communication with the marine vessel control system of marine vessel 1b to send information to marine vessel control system 13b, such as commands 15b, through a wired or wireless connection, as the techniques described herein are not limited to particular types of connections. Marine vessel control system 13b may map the commands 15b for marine vessel 1b into commands for the propulsor(s)/steering system/thruster(s) 14b of marine vessel 1b. Alternatively or additionally, marine vessel control system 13a may map commands 15b for marine vessel 1b into commands for the propulsor(s)/steering system/thruster(s) 14b of marine vessel 1b, which may minimize or eliminate the need for marine vessel control system 13b.

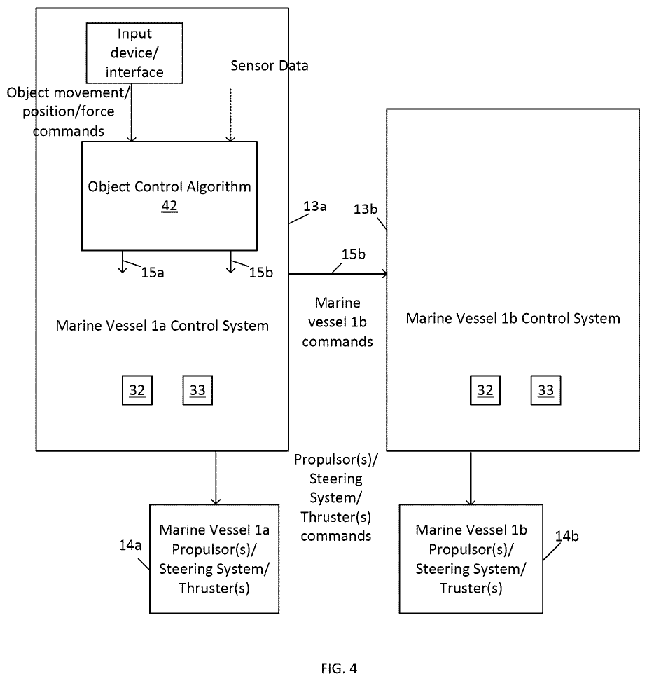

Any number of one or more marine vessels may be used to propel the assisted object 2. FIG. 5 shows an example in which four marine vessels 1a-1d are attached to and propel the assisted object 2. The object control system/algorithm discussed previously may control any one or more of the marine vessels 1a-1d. One or more of the marine vessels may not operate at a given time, and may provide redundancy, or may not provide redundancy and may ride along with the assisted object.

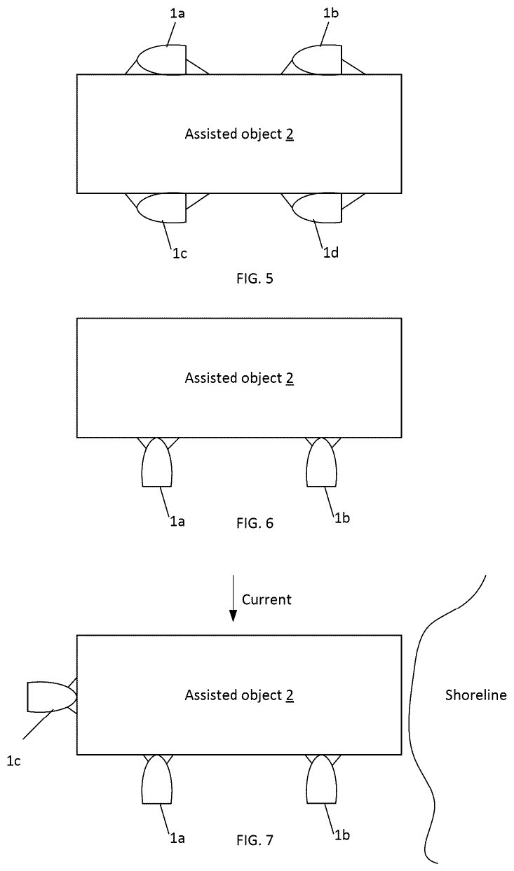

The marine vessels may be attached to the assisted object or other marine vessels in any suitable position, and may be on the same side of the assisted object or on different sides. FIGS. 1 and 5 show examples of a “longitudinal” configuration in which the centerlines of the marine vessels are parallel to the long axis of the assisted object. FIG. 6 shows an example of a “transverse” configuration in which marine vessels are attached to the assisted object 2 at their bows, with the centerline of the marine vessels being perpendicular to the long axis of the assisted object 2. Other embodiments may have different placements and/or a combination of “longitudinal” and “transverse” configurations. For example, FIG. 7 shows an example with three marine vessels in which marine vessels 1a and 1b are in a “transverse” configuration and marine vessel 1c is in a position in which its bow is facing one end (left side) of assisted object 2. Such a configuration may be useful in a situation where assisted object 2 is a bridge section being held in the current (flowing in the downward direction of FIG. 7) by marine vessels 1a and 1b and pushed toward a shoreline (right side) by marine vessel 1c.

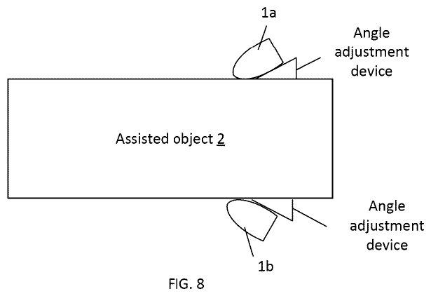

FIG. 8 shows a modified longitudinal configuration, in which the marine vessels 1a and 1b are attached to the assisted object 2 at an angle, i.e., the centerline of the marine vessels is at an angle (between 0 and 90 degrees) with respect to the main axis of the assisted object. Such a configuration may allow for the marine vessels to produce force angles beyond that which they can produce in a longitudinal or transverse configuration, which may allow for maneuvers not available in a longitudinal configuration. To position the marine vessels, an angle adjustment device may be attached between a marine vessel and the assisted object. The angle adjustment device may be a bumper, bar or other object that holds the marine vessel at an angle to the assisted object. In some embodiments, the angle adjustment device may be variable. That is, the angle adjustment device may adjust and vary the angle at which the marine vessel is positioned. For example, an angle adjustment device may include actuator that extends or retracts to change the angle at which the marine vessel is positioned. The angle may be controlled by the object position control system/algorithm, or a different automatic or manual control mechanism.

As mentioned above, the marine vessels may be arranged in a number of different positions or orientations. When the marine vessels are in different positions or orientations the force commands for the individual marine vessels to effect the same movement of the assisted object may vary. In some embodiments, the positions and/or orientations of the marine vessels may be input into the object control system or automatically detected using sensors. For example, the positions of the marine vessels may be detected using global navigation satellite system receivers on the marine vessels, or their positions determined through wireless communication (e.g., by triangulation), or sensors or devices that measure relative positions (e.g., radar, lidar, camera, ultrasound). The orientation may be detected using a compass or other sensor. Positions and/orientations sensed by sensors on the marine vessels or input at the marine vessels may be transmitted to the object control system. The object control system may use the received position and/or orientation system information to set or adjust parameters in the control algorithm and/or a mapping between movement or position commands received for the assisted object and force commands to be provided to the individual marine vessels.

The techniques described herein are not limited to the assist object being a floating object, or to marine vessels that operate on the surface. In some embodiments, any of the techniques described herein may be applied to underwater objects or craft. For example, in the embodiments described above, the “assisted object” may be a submersible or semi-submersible craft or other object, and the “marine vessels” may operate on the surface or below the surface as a submersible or semi-submersible craft. Alternatively the object need not be floating or submerged.

In some embodiments, a plurality of marine vessels may be attached to one another and their propulsor(s)/steering system/thruster(s) may be controlled in an integrated manner. Such a control technique may allow for a greater capability than the marine vessels have alone, such as a greater range, maneuverability, and/or reduced need for a human operator to control each vessel. The marine vessels that are mechanically connected together collectively form a mechanically connected object.

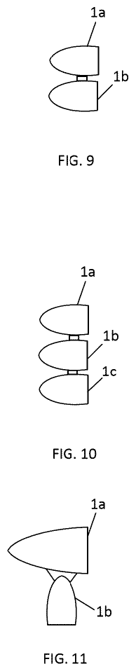

FIG. 9 shows an embodiment in which two marine vessels are attached to one another, and an integrated control system may control one or both vessels. The marine vessels 1a and 1b may be attached to one another by at least one attachment apparatus, which may be any device for attaching vessels to each other such as a bar, bracket, rope, a latch, or an integral part of one or more vessels, by way of example and not limitation. In some embodiments, the means of attachment (e.g., attachment apparatus) may transmit most, and optionally all forces and moments between the marine vessels. The marine vessel control system of one vessel may control both vessels in an integrated manner. For example, as shown in FIG. 4, the marine vessel control system 13a of marine vessel 1a may control the propulsor(s)/steering system/thruster(s) 14a and 14b of both vessels 1a and 1b. Alternatively, a separate control system, such as an object control system 12 (FIG. 3) may control the propulsor(s)/steering system/thruster(s) 14a and 14b of both vessels 1a and 1b. The marine vessels may have the same size and capabilities as one another or different sizes and/or capabilities.

FIG. 10 shows an embodiment in which three marine vessels are attached to one another, and an integrated control system may control one or more of the vessels. The marine vessel control system of one or more vessels may control two or more vessels in an integrated manner. For example, the marine vessel control system 13a of marine vessel 1a may control the propulsor(s)/steering system/thruster(s) of all three vessels. Alternatively, a separate control system, such as an object control system 12 (FIG. 3) may control the propulsor(s)/steering system/thruster(s) of the three vessels. The separate control system may be located on one or more of the marine vessels and/or at a remote location. Again, the marine vessels may have the same size and capabilities as one another or different sizes and/or capabilities. FIG. 11 shows an embodiment similar to that of FIG. 9, with the marine vessel 1b being attached to the side of marine vessel 1a in a transverse configuration. The marine vessel control system of one vessel may control both vessels in an integrated manner. For example, as shown in FIG. 4, the marine vessel control system 13a of marine vessel 1a may control the propulsor(s)/steering system/thruster(s) 14a and 14b of both vessels 1a and 1b. Alternatively, a separate control system, such as an object control system 12 (FIG. 3) may control the propulsor(s)/steering system/thruster(s) 14a and 14b of both vessels 1a and 1b.

Various aspects of the apparatus and techniques described herein may be used alone, in combination, or in a variety of arrangements not specifically discussed in the embodiments described in the foregoing description and is therefore not limited in its application to the details and arrangement of components set forth in the foregoing description or illustrated in the drawings. For example, aspects described in one embodiment may be combined in any manner with aspects described in other embodiments.

The processors described in the above-described embodiments can be implemented in any of numerous ways. It should be appreciated that software code can be executed on any suitable processor (e.g., a microprocessor) or collection of processors. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above. The terms “computer program” and “software” are used herein in a generic sense to reference any type of computer code (e.g., application software, firmware, microcode, or any other form of computer instruction) that can be employed to program one or more processors to implement aspects of the techniques discussed herein. The software may be stored on at least one computer readable storage medium. The at least one computer readable medium may have stored thereon instructions, which, when executed by at least one processor, perform a method of performing the control techniques described herein.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A control system for controlling movement, position, or force for a mechanically connected object comprising a plurality of marine vessels, the control system comprising:
at least one processor configured to:
receive a movement, position or force command for the mechanically connected object; and
generate at least one first command for a first marine vessel of the plurality of marine vessels and at least one second command for a second marine vessel of the plurality of marine vessels, to control movement, position, or force of the mechanically connected object in response to the movement, position or force command for the mechanically connected object.

2. The control system of claim 1, wherein the mechanically connected object further comprises an assisted object.

3. The control system of claim 1, wherein the control system further comprises at least one memory storing computer readable instructions for the at least one processor to generate the at least one first command and the at least one second command.

4. The control system of claim 1, wherein the control system is configured to provide the at least one first command to the first marine vessel and the at least one second command to the second marine vessel.

5. The control system of claim 2, wherein the control system is located at the assisted object or located remotely from the mechanically connected object.

6. The control system of claim 2, wherein the control system receives a control input from an input device located at the assisted object or located remotely from the mechanically connected object.

7. The control system of claim 4, wherein the control system is configured to provide the at least one first command to the first marine vessel and the at least one second command to the second marine vessel through wireless communication.

8. The control system of claim 4, wherein the control system is configured to configured to provide the at least one first command to a first marine vessel control system of the first marine vessel and to provide the at least one second command to a second marine vessel control system of the second marine vessel.

9. The control system of claim 1, wherein a marine vessel control system for the first marine vessel at least partially implements the control system for controlling movement of the mechanically connected object.

10. The control system of claim 9, wherein the control system receives a control input from an input device located at the first marine vessel, and the control system controls both the first marine vessel and the second marine vessel.

11. The control system of claim 9, wherein the control system is configured to provide the at least one second command to the second marine vessel.

12. The control system of claim 11, wherein the control system is configured to provide the at least one second command to the second marine vessel through wireless communication.

13. The control system of claim 9, wherein the control system is configured to provide the at least one second command to a second marine vessel control system of the second marine vessel.

14. The control system of claim 1, wherein the control system is configured to maintain a position.

15. The control system of claim 1, wherein the control system is configured to receive the movement, position or force command from a human operator, an autonomous system or a remotely controlled system.

16. The control system of claim 1, wherein the control system is configured to control the first marine vessel and the second marine vessel such that the mechanically connected object keeps station or transits at least partially across a body of water.

17. The control system of claim 2, wherein the control system is configured to detect a position and/or orientation of the first and second marine vessels relative to the assisted object or each other.

18. The control system of claim 2, wherein the control system is configured to adjust the position and/or orientation of the first and/or second marine vessels relative to the assisted object or each other.

19. The control system of claim 16, wherein the control system is configured to set or adjust one or more control parameters based on the position and/or orientation of the first and second marine vessels relative to the assisted object or each other.

20. The control system of claim 2, wherein the control system is configured to control a plurality of marine vessels attached to the assisted object when one or more of the plurality of marine vessels are in longitudinal configuration, a modified longitudinal configuration and/or a transverse configuration.

21. The control system of claim 2, wherein the first and second marine vessels are attached to the assisted object at an angle that is different corresponding to an angle corresponding to a longitudinal or transverse arrangement.

22. (canceled)

23. A method of controlling movement, position, or force of a mechanically connected object comprising a plurality of marine vessels, the method comprising, by at least one processor:
receiving a movement, position or force command for the mechanically connected object; and
generating at least one first command for a first marine vessel of the plurality of marine vessels and at least one second command for a second marine vessel of the plurality of marine vessels, to control movement, position, or force of the mechanically connected object in response to the movement, position or force command.

24. At least one computer readable storage medium having stored thereon instructions, which, when executed by at least one processor, perform a method of controlling movement, position, or force of a mechanically connected object comprising a plurality of marine vessels, the method comprising:
receiving a movement, position or force command for the mechanically connected object; and
generating at least one first command for a first marine vessel of the plurality of marine vessels and at least one second command for a second marine vessel of the plurality of marine vessels, to control movement, position, or force of the mechanically connected object in response to the movement, position or force command.
